(19) United States
(12) Patent Application Publication
(10) Pub. No.: US 2016/0142507 A1
(43) Pub. Date: May 19, 2016

(54) CACHING CONTENT

(71) Applicant: TELEFONAKTIEBOLAGET L M ERICSSON (PUBL), Stockholm (SE)

(72) Inventor: Michael John SLSSINGAR, SKÄRHOLMEN (SE)

(73) Assignee: TELEFONAKTIEBOLAGET L M ERICSSON (PUBL), Stockholm (SE)

(21) Appl. No.: 14/902,161

(22) PCT Filed: Jul. 2, 2013
(86) PCT No.: PCT/SE2013/050844

§ 371 Date: Dec. 30, 2015

(51) Int. Cl. H04L 29/08

(52) U.S. Cl. CPC H04L 67/2842; H04L 67/2852

(57) ABSTRACT

It is presented a method for obtaining caching content. The method is performed in a client device and comprises the steps of: receiving caching content from a net-work node, the transmission of caching content being initiated by the network node; storing the caching content in a client device cache; determining a need to obtain requested content; checking whether the client device cache comprises caching content corresponding to the requested content; and obtaining the requested content from the client device cache when the client device cache comprises caching content corresponding to the requested content A corresponding client device, network node, computer programs, computer program products and a vehicle are also presented.

### TECHNICAL FIELD

The invention relates to methods, a client device, a network node, computer programs, computer program products and a vehicle for caching content.

### BACKGROUND

Content distribution is a challenging task in cellular communication networks and other type of networks. In particular, with increased popularity of video content, higher requirements on bandwidth results in a higher strain on the networks.

One way to reduce network traffic is by caching. With caching, a device in the network stores a piece of content, which then reduces the need for content delivery over the network when a piece of content is requested which is stored in the cache.

However, the caching solutions in the prior art fail to significantly reduce network traffic for when a piece of content gains popularity, but may only be consumed very few times. Such content can e.g. be viral videos, breaking news or video links being spread on social networks.

### SUMMARY

It is an object to provide a way of caching content which is proactive and which can reduce network traffic for popular content even before a user requests the content.

According to a first aspect, it is presented a method for obtaining caching content. The method is performed in a client device and comprises the steps of: receiving caching content from a network node, the transmission of caching content being initiated by the network node; storing the caching content in a client device cache; determining a need to obtain requested content; checking whether the client device cache comprises caching content corresponding to the requested content; and obtaining the requested content from the client device cache when the client device cache comprises caching content corresponding to the requested content.

The step of storing may comprise storing the caching content in an encrypted form.

The method may further comprise the step of: receiving a cache retention policy from the network node; and discarding caching content when expired in accordance with the cache control policy.

The step of receiving caching content may comprise receiving caching content over a broadcast connection.

The method may further comprise the step of: transmitting usage data indicative of usage of content cached in the client device cache.

The method may further comprise the step of: receiving a reporting policy from the network node; in which case the step of transmitting usage data comprises transmitting usage data in accordance with the reporting policy.

In the step of receiving a reporting policy, the reporting policy may comprise an indication to encrypt usage data; in which case the step of transmitting usage data comprises encrypting the usage data and transmitting the encrypted usage data.

The method may further comprise the step, prior to the step of checking, of: receiving auxiliary caching content from a network node, the transmission of the auxiliary caching content being initiated by the network node; in which case the step of obtaining the requested content comprises combining the requested content and the auxiliary caching content.

According to a second aspect, it is presented a client device for obtaining caching content. The client device comprises: a processor; and a memory storing instructions that, when executed by the processor, causes the client device to: receive caching content from a network node, the transmission of caching content being initiated by the network node; store the caching content in a client device cache; determine a need to obtain requested content; check whether the client device cache comprises caching content corresponding to the requested content; and obtain the requested content from the client device cache when the client device cache comprises caching content corresponding to the requested content.

The instructions to store may comprise instructions that, when executed by the processor, causes the client device to store the caching content in an encrypted form.

The client device may further comprise instructions that, when executed by the processor, causes the client device to: receive a cache retention policy from the network node; and discard caching content when expired in accordance with the cache control policy.

The instructions to receive caching content may comprise instructions that, when executed by the processor, causes the client device to receive caching content over a broadcast connection.

The client device may further comprise instructions that, when executed by the processor, causes the client device to: transmit usage data of the client device cache.

The client device may further comprise instructions that, when executed by the processor, causes the client device to: receive a reporting policy from the network node; in which case the instructions to transmit usage data comprise instructions to transmit usage data in accordance with the reporting policy.

The reporting policy may comprise an indication to encrypt usage data; in which case the instructions to transmit usage data comprises instructions that, when executed by the processor, causes the client device to encrypt the usage data and transmitting the encrypted usage data.

The client device may further comprise instructions that, when executed by the processor, causes the client device to: receive auxiliary caching content from a network node, the transmission of the auxiliary caching content being initiated by the network node; in which case the instructions to obtain the requested content comprise instructions to combine the requested content and the auxiliary caching content.

According to a third aspect, it is presented a client device comprising means for receiving caching content from a network node, the transmission of caching content being initiated by the network node; means for storing the caching content in a client device cache; means for determining a need to obtain requested content; means for checking whether the client device cache comprises caching content corresponding to the requested content; and means for obtaining the requested content from the client device cache when the client device cache comprises caching content corresponding to the requested content.

The means for storing may comprise storing the caching content in an encrypted form.

The client device may further comprise means for receiving a cache retention policy from the network node; and discarding caching content when expired in accordance with the cache control policy.

The means for receiving caching content may comprise receiving caching content over a broadcast connection.

The client device may further comprise means for transmitting usage data indicative of usage of content cached in the client device cache.

The client device may further comprise means for receiving a reporting policy from the network node; in which case the means for transmitting usage data comprises means for transmitting usage data in accordance with the reporting policy.

In the means for receiving a reporting policy, the reporting policy may comprise an indication to encrypt usage data; in which case the means for transmitting usage data comprises means for encrypting the usage data and transmitting the encrypted usage data.

The client device may further comprise means for receiving auxiliary caching content from a network node, the transmission of the auxiliary caching content being initiated by the network node; in which case the means for obtaining the requested content comprises means for combining the requested content and the auxiliary caching content.

According to a fourth aspect, it is presented a vehicle comprising the client device according to the second aspect or the third aspect.

According to a fifth aspect, it is presented a computer program comprising computer program code which, when run on a client device, causes the client device to: receive caching content from a network node, the transmission of caching content being initiated by the network node; store the caching content in a client device cache; determine a need to obtain requested content; check whether the client device cache comprises caching content corresponding to the requested content; and obtain the requested content from the client device cache when the client device cache comprises caching content corresponding to the requested content.

According to a sixth aspect, it is presented a computer program product comprising a computer program according to the fifth aspect and a computer readable means on which the computer program is stored.

According to a seventh aspect, it is presented method for providing caching content to client devices. The method being performed in a network node and comprises the steps of: determining a need to store caching content in the client devices; and transmitting caching content to the client devices, the transmission of caching content being initiated by the network node.

The step of transmitting caching content may comprise transmitting caching content over a broadcast connection.

The step of transmitting caching content may comprise transmitting encrypted caching content.

The method may further comprise the step of: transmitting auxiliary caching content to the client devices for combining with caching content, the transmission of the auxiliary caching content being initiated by the network node.

The method may further comprise the step of: transmitting a cache retention policy to the client devices.

The method may further comprise the step of: transmitting a reporting policy to the client devices.

According to an eighth aspect, it is presented a network node for providing caching content to client devices. The network node comprises: a processor; and a memory storing instructions that, when executed by the processor, causes the network node to: determine a need to store caching content in the client devices; and transmit caching content to the client devices, the transmission of caching content being initiated by the network node.

The instructions to transmit caching content may comprise instructions that, when executed by the processor, causes the client device to transmit caching content over a broadcast connection.

The instructions to transmit caching content may comprise instructions that, when executed by the processor, causes the client device to transmit caching content.

The network node may further comprise instructions that, when executed by the processor, causes the client device to: transmit auxiliary caching content to the client devices for combining with caching content, the transmission of the auxiliary caching content being initiated by the network node.

The network node may further comprise instructions that, when executed by the processor, causes the client device to: transmit a cache retention policy to the client devices.

The network node may further comprise instructions that, when executed by the processor, causes the client device to: transmit a reporting policy to the client devices.

According to a ninth aspect, it is presented a network node comprising means for determining a need to store caching content in the client devices; and means for transmitting caching content to the client devices, the transmission of caching content being initiated by the network node.

The means for transmitting caching content may comprise means for transmitting caching content over a broadcast connection.

The means for transmitting caching content may comprise means for transmitting encrypted caching content.

The network node may further comprise means for transmitting auxiliary caching content to the client devices for combining with caching content, the transmission of the auxiliary caching content being initiated by the network node.

The network node may further comprise means for transmitting a cache retention policy to the client devices.

The network node may further comprise means for transmitting a reporting policy to the client devices.

According to a tenth aspect, it is presented a computer program comprising computer program code which, when run on a network node, causes the network node to: determine a need to store caching content in the client devices; and transmit caching content to the client devices, the transmission of caching content being initiated by the network node.

According to an eleventh aspect, it is presented a computer program product comprising a computer program according to the tenth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment in which embodiments presented herein can be applied;

FIG. 2 is a sequence diagram illustrating communication between a network node and a client device of FIG. 1 for caching content;

FIG. 3 is a sequence diagram illustrating communication between a network node, a client device and a content server of FIG. 1 for when there is a cache miss;

FIGS. 4A-B are flow charts illustrating methods performed in a client device of FIG. 1 for caching content;

FIGS. 5A-B are flow charts illustrating methods performed in the network node of FIG. 1 for caching content;

FIG. 6 is a schematic diagram showing some components of the network node of FIG. 1;

FIG. 7 is a schematic diagram showing some components of the client device of FIG. 1;

FIG. 8 is a schematic diagram showing functional modules of the network node of FIGS. 1 and 6;

FIG. 9 is a schematic diagram showing functional modules of the client device of FIGS. 1 and 7;

FIG. 10 shows one example of a computer program product comprising computer readable means; and

FIG. 11 is a schematic diagram illustrating a vehicle comprising the client device 2 of FIGS. 1, 7 and 9.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

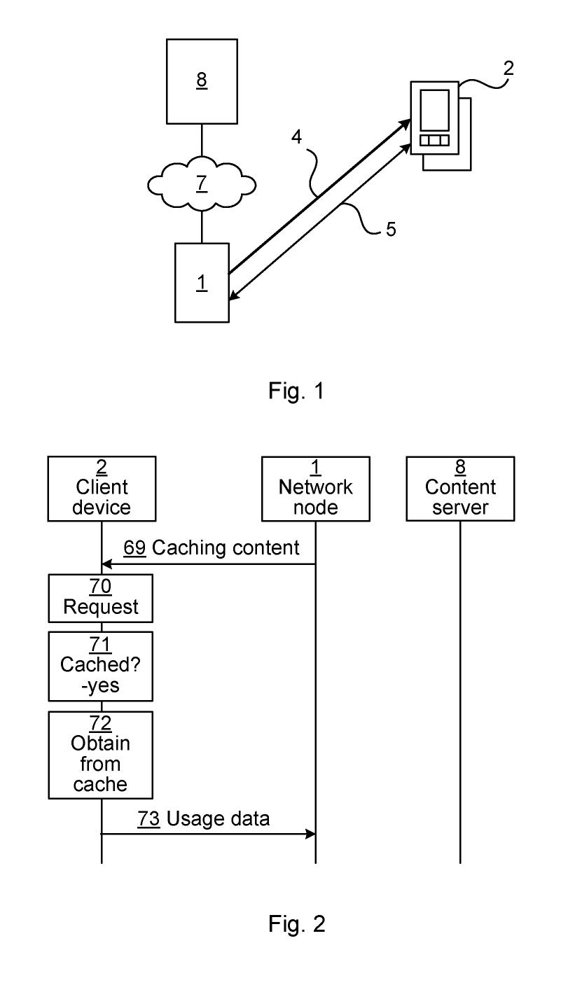

FIG. 1 is a schematic diagram illustrating an environment in which embodiments presented herein can be applied. A content server 8 provides content to be presented on one or more client devices 2. The content can e.g. comprise video, audio, still images and/or text. The content server 8 is connected via a network 7 to a network node 1. The network 7 can be a local area network and/or a wide area network such as the Internet, allowing great physical separation between the content server 8 and the network node 1.

The network node 1 controls what content is to be cached in a client device cache (not shown) in the client devices 2. There is a point to multipoint (P2MP) downlink connection 4 between the network node 1 and the client devices 2. The P2MP connection 4 can e.g. comprise a broadcast connection, e.g. using Multimedia Broadcast Multicast Service (MBMS) or eMBMS (evolved MBMB) as specified by 3GPP (Third Generation Partnership Project), over a cellular communication network. Alternatively or additionally, the P2MP connection comprises a multicast connection, e.g. using IP (Internet Protocol) multicast, MBMS or eMBMS. There is also a bi-directional unicast connection 5 between the network node 1 and each one of the client devices 2. The unicast connection 5 can e.g. be a regular IP connection e.g. using a cellular communication network. In one embodiment, there is one such network node 1 for each operator. In one embodiment, there are several network nodes 1, each one of which is responsible for a subset of the network, e.g. for a subset of cells of a cellular communication network.

When a cellular communication network is used for the P2MP connection 4 and/or the bi-directional unicast connection 5, the cellular communication network can be any suitable network allowing communication between the network node 1 and the client devices 2 as described below. The cellular communication network can e.g. comply with any one or a combination of LTE (Long Term Evolution), UMTS utilising W-CDMA (Wideband Code Division Multiplex), CDMA2000 (Code Division Multiple Access 2000), or any other current or future wireless network, as long as the principles described hereinafter are applicable.

The network node 1 is any device capable of performing one or more of the embodiments presented herein to be performed by the network node 1. For example, the network node 1 can be implemented using a server. Optionally, the network node 1 is implemented using a plurality of servers, e.g. for improved failure handling capabilities and/or load balancing.

Alternatively or additionally, the P2MP connection 4 and/or the bi-directional unicast connection 5 may comply with other suitable wireless standards such as WiFi (e.g. any of the IEEE 802.11x standards) or WiMAX (Worldwide Interoperability for Microwave Access).

The client devices 2 can be implemented in any suitable way to allow a user to consume content. For example, the client devices 2 can be implemented using any one or more of a mobile communication terminal (also known as a user equipment, cellular phone, smartphone or mobile phone), a tablet computer, a portable general purpose computer, etc. The client devices 2 may optionally be included in a host device, such as a media player, a vehicle, etc.

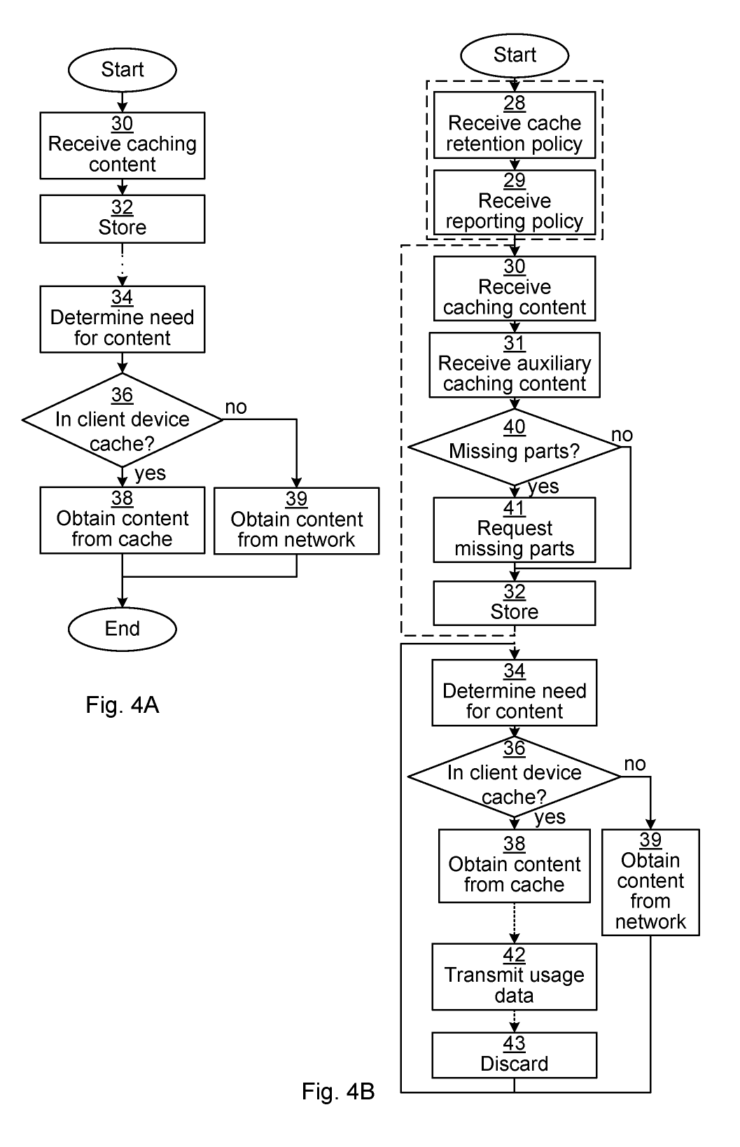

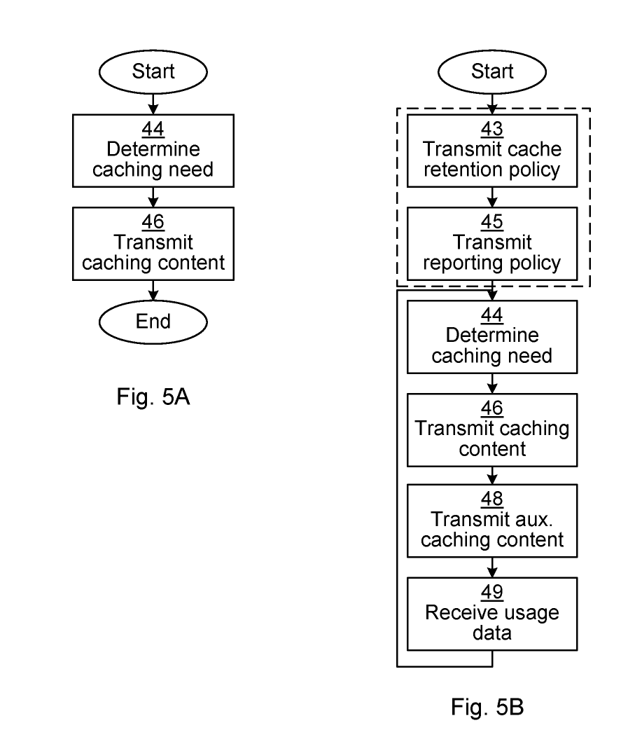

FIG. 2 is a sequence diagram illustrating communication between a network node 1 and a client device 2 of FIG. 1 for caching content, when there is a cache hit. More details are described below with reference to the flow charts of FIGS. 4A-B and FIGS. 5A-B.

The network node 1 pushes caching content 69 to the client device 2. It is to be noted that the distribution of caching content is controlled by the network node 1 and not by the client device 2. In this way, popular content can be identified and pushed to the client device to make the content available locally.

When a request 70 for a particular piece of content is generated in the client device, the cache is checked 71. In this example, there is a hit, i.e. the piece of content is found in the cache.

The client device 2 then obtains the content from the cache 72, without having to communicate with any other nodes.

Eventually, the client device 2 sends usage data 73 to the network node 1, to allow the network node 1 (or other nodes in the network) to gather statistics on cache performance and/or usage. The usage data indicates what content in the client device cache is consumed. The usage data may also indicate for how long the content is and whether the user skips particular parts of the content.

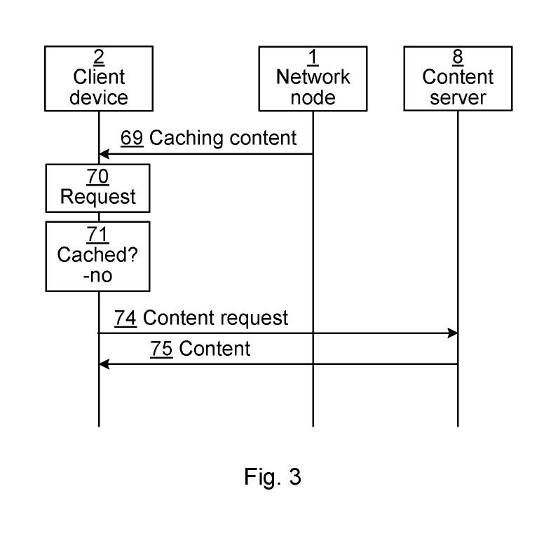

FIG. 3 is a sequence diagram illustrating communication between a network node 1, a client device 2 and a content server 8 of FIG. 1 for caching content when there is a cache miss. This sequence is similar to the sequence of FIG. 2 and only differences will be described here.

When a request 70 for a particular piece of content is generated in the client device, the cache is checked 71. In this example, there is a miss, i.e. the piece of content is not found in the cache.

Hence, the client device 2 sends a content request 74 to the content server 8, which responds with the content 75 in question, either with a file transfer, e.g. using HTTP (Hypertext Transfer Protocol) or FTP (File Transfer Protocol), or with streaming media, e.g. using MBMS or RTP (Real-time Transfer Protocol).

FIG. 4A is a flow chart illustrating one embodiment of a method for caching content. The method is performed in the client device 2 of FIG. 1.

In a receive caching content step 30, caching content is received from a network node, the transmission of caching content being initiated by the network node. In other words, the caching content is pushed to the client device from, and controlled by, the network node.

In one embodiment, the caching content is received over a broadcast connection. Broadcast connections are particularly resource efficient when one piece of content is to be distributed to many client devices, such as for populating client device caches with caching content.

In one embodiment, the caching content is received over a multicast connection. Multicast connections can also be used for efficient distribution of caching content to a plurality of client devices.

In one embodiment, the caching content is received over a unicast connection. While unicast connections are not as efficient for distributing caching content to a plurality of client devices, the unicast connection is more often available and requires no extra infrastructure to support caching content distribution using broadcast and/or multicast connections.

In a store step 32, the caching content is stored in a client device cache in the client device. Optionally, the caching content is stored in an encrypted form. A user of the client device is thereby not able to discover or de-encrypt the client device cache contents unless a request is made (by the user) for a specific piece of content which results in a cache hit in the client device cache.

In a determine need for content step 34, a need to obtain requested content is determined. For example, this can be an HTTP request for a piece of content.

In a conditional in client device cache step 36, the client device checks whether the client device cache comprises caching content corresponding to the requested content, i.e. whether there is a hit in the client device cache. If this is true, the method continues to an obtain content from cache step 38. Otherwise, the method continues to an obtain content from network step 39. This step can e.g. use a URI (Uniform Resource Identifier), such as an URL (Uniform Resource Locator) as a key for checking the content of the client device cache.

In the obtain content from cache step 38, the requested content is obtained from the client device cache when the client device cache comprises caching content corresponding to the requested content. In this way, no network traffic is generated to make the requested content available.

In the obtain content from network step 39, the requested content is obtained from the content server, e.g. using file transfer or streaming.

The conditional in client device step 36, obtain content from cache step 38 and obtain content from network step 39 can e.g. be realised by a cache being implemented using an HTTP proxy. In this way, HTTP requests for content stored in the client device cache are served from locally stored content and HTTP requests for content not stored in the client device cache are routed to conventional content source. Using an HTTP proxy gives a transparency to applications of the client device requesting the content. In other words, the applications are not aware of any client device cache presence and do not need to be modified in any way to take advantage of the client device cache.

It is to be noted that there may be additional caches in the network upstream from the client device which are not described in more detail here.

Using this method, the network node can preload content into the client device cache. This makes the content available even prior to the user of the client device having indicated an interest in the piece of content. For example, content can become extremely popular in a short amount time and by preloading the content in client device caches, the network is relieved of later having to serve each individual request for the piece of content.

FIG. 4B is a flow chart illustrating one embodiment of a method for caching content. The method of FIG. 4B is similar to the method of FIG. 4A and only steps which are new or modified compared to the method of FIG. 4A are described here. In this embodiment, optional functionality is included, such as caching policies, auxiliary content and user data reporting.

In an optional receive cache retention policy step 28, a cache retention policy is received from the network node. This is used for the client device to know when it should discard caching content stored in the client device cache.

In an optional receive reporting policy step 29, a reporting policy is received from the network node. The reporting policy is used to control how usage data is transmitted to the network node. The reporting policy may comprise an indication to encrypt usage data when it is sent to the network from the client device.

In one embodiment, the cache retention policy and reporting policy are combined in a single message and thus received together.

It is to be noted that the receive cache retention policy step 28 and the receive reporting policy step 29 do not need to be performed sequentially in relation to the other steps and can be performed in one or more separate execution processes.

The retention policy and the reporting policy can be received over the same connection type (e.g. broadcast, multicast or unicast) as the caching content, or using another connection type.

In an optional receive auxiliary caching content step 31, auxiliary caching content is received from the network node. Also the transmission of the auxiliary caching content is initiated by the network node. The auxiliary caching content is optionally encrypted. The auxiliary caching content can e.g. be advertisements.

In an optional conditional missing parts step 40, it is determined whether there are any missing parts in the received caching content. If this is the case, the method continues to a request missing parts step 41. Otherwise, the method continues to the store step 32. The missing parts can e.g. be a missing IP packet or a discarded IP packet due to CRC (Cyclic Redundancy Check) failure.

In the request missing parts step 41, the missing parts are requested from the network node or from the content server. The missing parts can be delivered over a unicast connection, a multicast connection or over a broadcast connection.

In the obtain content from cache step 38, when there is auxiliary content, the auxiliary content can be combined with the requested content. This can e.g. be a concatenation of the auxiliary content and the requested content into one file. The auxiliary content can e.g. be advertisements which could be general advertisements or advertisements which are tailored to the user of the particular client device or for a geographical area.

In an optional transmit usage data step 42, usage data of the client device cache is transmitted to the network node. When a reporting policy has been received, this step comprises transmitting usage data in accordance with the reporting policy. For example, when the reporting policy comprises an indication to encrypt usage data, this step comprises encrypting the usage data and transmitting the encrypted usage data. Moreover, when auxiliary content (such as advertisements) is provided, usage data can include statistics on how much of the auxiliary content is shown and whether any hyperlinks in the auxiliary content are followed.

In an optional discard step 43, caching content is discarded when expired in accordance with the cache control policy. This implies that a timer functionality is initiated when respective content is being cached.

It is to be noted that the transmit user data step 42 and discard step 43 do not need to be performed sequentially in relation to the other steps and can be performed in separate execution processes. Moreover, the steps from the determine need for content step 34 to the obtain steps 38-39 can be performed independently from the other steps.

FIG. 5A is a flow chart illustrating one embodiment of a method for caching content in a client device, being one of client devices 2 of FIG. 1. The method is performed in the network node 1 of FIG. 1. The method is executed for a set of client devices.

In a determine caching need step 44, the network node determines a need to store caching content in the client devices. This can e.g. be due to an increased popularity of a particular piece of content in the network. In one embodiment, there is a threshold value which a popularity measurement for a piece of content needs to exceed for the network node to determine that there is a need to cache the piece of content in question.

Optionally, this can include a geographical aspect, whereby the network node determines that a piece of content is to be cached in client devices in a particular area. This can be useful in situations such as concerts or sport events, where a large number of users in a limited geographical area may request or may be expected to request the same piece of content from the network.

Rules for determining what content is to be cached in the client device caches can optionally be configured by the operator of the network.

In a transmit caching content step 46, caching content is transmitted to the client devices. This transmission of caching content is initiated by the network node. In other words, the caching content is pushed to the client devices and is not a direct result of a request for content from a client device, in contrast to conventional distribution of content which may be cached by client devices. Optionally, the caching content is encrypted prior to transmitting to the client devices. Since the users of the client devices are not in control of what content is to be cached on the client devices, encryption prevents the users of the client device from browsing the client device cache and makes unapproved access (e.g. by hacking the client device) to the client device cache significantly more difficult. Moreover, there may be situations where popular content may be morally questionable to some users, but is still pushed to client devices due to client device caching rules. In such situations, the encryption of the content prevents users from even knowing what content is stored in the client device cache, and the content is only made available when explicitly requested by the users.

In one embodiment, the content is transmitted to the client devices over a broadcast connection.

In one embodiment, the content is transmitted to the client devices over a multicast connection.

In one embodiment, the content is transmitted to the client devices over a unicast connection.

FIG. 5B is a flow chart illustrating one embodiment of a method for caching content. The method of FIG. 5B is similar to the method of FIG. 5A and only steps which are new of modified compared to the method of FIG. 5A are described here. In this embodiment, optional functionality is included, such as providing caching policies to client devices, providing auxiliary content and receiving user data reporting.

In an optional transmit cache retention policy step 43, the cache retention policy is transmitted to the client devices. This step corresponds to the receive cache retention policy step 28 of FIG. 4B.

In an optional transmit reporting policy step 45, the reporting policy is transmitted to the client devices. This step corresponds to the receive reporting policy step 29 of FIG. 4B.

In an optional transmit auxiliary caching content step 48, auxiliary caching content is transmitted to the client devices for combining with caching content. In one embodiment, specific caching content can be combined with specific auxiliary caching content, at the network node, e.g. at the choice of the operator or service provider. Also the transmission of the auxiliary caching content is initiated by the network node.

In an optional receive usage data step 49, usage data is received from the client devices. This step corresponds to the transmit usage data step 42 of FIG. 4B. The usage data can e.g. be used as part in the determination of what content is popular in the determine caching need step 44. The usage data can then be aggregated and used for post-processing and analysis. Optionally, the usage data can also be used for charging.

It is to be noted that the receive usage data step 49 may be performed independently for the other steps of this method.

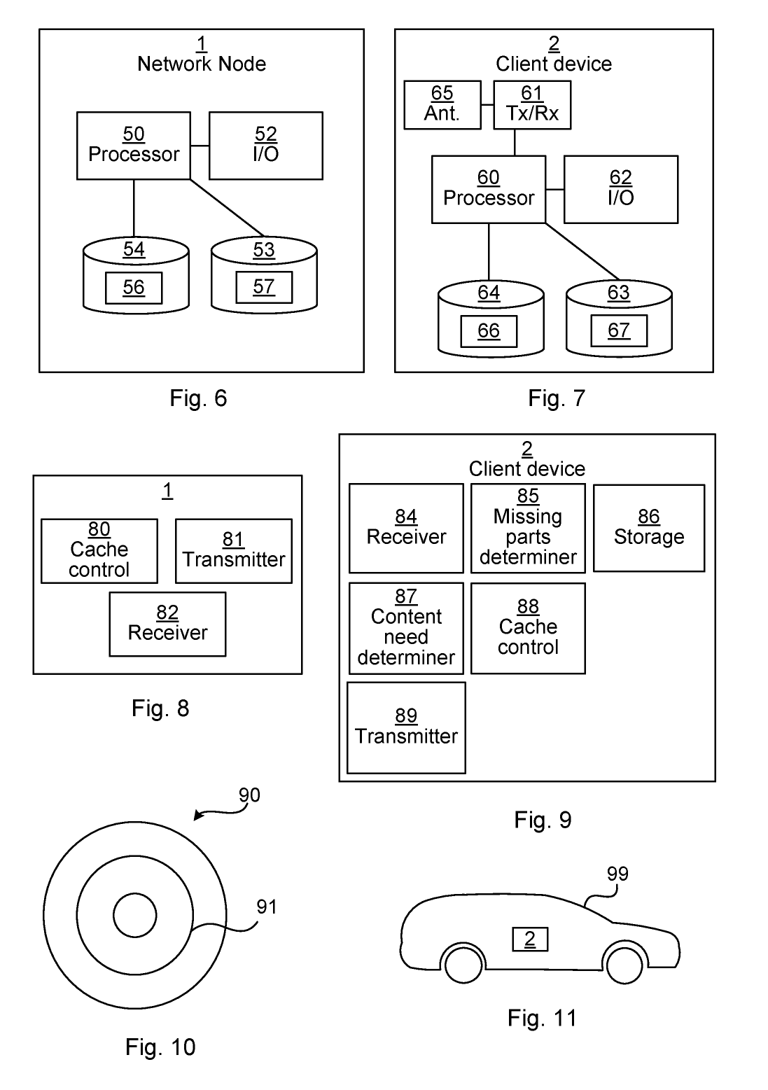

FIG. 6 is a schematic diagram showing some components of the network node of FIG. 1. A processor 50 is provided using any combination of one or more of a suitable central processing unit (CPU), multiprocessor, microcontroller, digital signal processor (DSP), application specific integrated circuit etc., capable of executing software instructions 56 stored in a memory 54, which can thus be a computer program product. The processor 50 can be configured to execute the methods described with reference to FIGS. 5A-B above.

The memory 54 can be any combination of read and write memory (RAM) and read only memory (ROM). The memory 54 also comprises persistent storage, which, for example, can be any single one or combination of magnetic memory, optical memory, solid state memory or even remotely mounted memory.

A data memory 53 is also provided for reading and/or storing data 57 during execution of software instructions in the processor 50. The data memory 53 can be any combination of read and write memory (RAM) and read only memory (ROM).

The network node 1 further comprises an I/O interface 52 for communicating with other external entities, e.g. using a wired network connection such as Ethernet. Optionally, the I/O interface 52 also includes a user interface.

The network node 1 optionally comprises one or more transceivers (not shown), comprising analogue and digital components, and a suitable number of antennas (not shown) for wireless communication with client devices.

The network node 1 can be a device for the purposes described herein. Alternatively, the network node forms part of a device providing also other functionality, such as a radio base station, or a Broadcast/Multicast Service Center (BMSC).

Other components of the network node 1 are omitted in order not to obscure the concepts presented herein.

FIG. 7 is a schematic diagram showing some components of the client devices of FIG. 1, here represented by a single client device 2. As mentioned above, the client devices 2 can be implemented using any one or more of a mobile communication terminal (also known as a user equipment, cellular phone, smartphone or mobile phone), a tablet computer, a portable general purpose computer, etc. The client devices 2 may optionally be included in a host device, such as a media player, a vehicle, etc.

A processor 60 is provided using any combination of one or more of a suitable central processing unit (CPU), multiprocessor, microcontroller, digital signal processor (DSP), application specific integrated circuit etc., capable of executing software instructions 66 stored in a memory 64, which can thus be a computer program product. The processor 60 can be configured to execute the methods described with reference to FIGS. 4A-B above.

The memory 64 can be any combination of read and write memory (RAM) and read only memory (ROM). The memory 64 also comprises persistent storage, which, for example, can be any single one or combination of magnetic memory, optical memory, solid state memory or even remotely mounted memory.

A data memory 63 is also provided for reading and/or storing data during execution of software instructions in the processor 60. The data memory 63 can be any combination of read and write memory (RAM) and read only memory (ROM), e.g. in the form of a persistent storage, which, for example, can be any single one or combination of magnetic memory, optical memory, solid state memory or even remotely mounted memory. The data memory 63 can e.g. comprise a client device cache 67 for storing content under the control of a network node.

The client device 2 further comprises an I/O interface 62 for communicating with other external entities such as the network node, e.g. using a wired network connection such as Ethernet. The I/O interface can optionally comprise a basic or more complete user interface including any of a display, input devices (input keys, touch sensitivity of the display, etc.), speaker, microphone, etc.

The client device 2 also comprises one or more transceivers 61, comprising analogue and digital components, and a suitable number of antennas 65 for wireless communication with the network node.

Other components of the client device 2 are omitted in order not to obscure the concepts presented herein.

FIG. 8 is a schematic diagram showing functional modules of the network node 1 of FIGS. 1 and 6. The modules can be implemented using software instructions such as a computer program executing in the network node 1 and/or using hardware, such as application specific integrated circuits, field programmable gate arrays, discrete logical components, transceivers, etc. The modules correspond to the steps in the methods illustrated in the flow charts of FIGS. 5A-B.

A cache control module 80 is arranged to determine a caching need for client devices and may also make use of usage data provided from client devices when determining a caching need. This module corresponds to the determine caching need step 44 of FIGS. 5A-B.

A transmitter 81 is arranged to transmit caching content and optionally the auxiliary caching content, cache retention policy and reporting policy to the client devices. This module corresponds to the transmit caching content step 46 of FIGS. 5A-B and the transmit cache retention policy step 43, the transmit reporting policy step 45 and the transmit auxiliary caching content step 48 of FIG. 5B.

A receiver 82 is arranged to receive usage data from client devices. This module corresponds to the receive usage data step 49 of FIG. 5B.

FIG. 9 is a schematic diagram showing functional modules of the client device of FIGS. 1 and 7. The modules can be implemented using software instructions such as a computer program executing in the network node 1 and/or using hardware, such as application specific integrated circuits, field programmable gate arrays, discrete logical components, transceivers, etc. The modules correspond to the steps in the methods illustrated in the flow charts of FIGS. 4A-B.

A receiver 84 is arranged to receive the caching content. Optionally the receiver 84 is arranged to receive the cache retention policy, the reporting policy and auxiliary content. This module corresponds to the receive caching content step 30 of FIGS. 4A-B and the receive cache retention policy step 28, the receive reporting policy step 29 and receive auxiliary caching content step 31 of FIG. 4B.

An optional missing parts determiner 85 is arranged to determine whether there are any missing parts in received caching content. This module corresponds to the conditional missing parts step 40 of FIG. 4B.

A storage module 86 is arranged to store caching content and any auxiliary caching content. This module corresponds to the store step 32 of FIG. 4B.

A content need determiner 87 is arranged to determine when there is a need for content. This step corresponds to the determine need for content step 34 of FIGS. 4A-B.

A cache control module 88 is arranged to control the client device cache. In particular it is arranged to obtain content from cache and optionally to discard content. This module corresponds to the conditional in client device cache step 36 and obtain content from cache step 38 of FIGS. 4A-B and the discard step 43 of FIG. 4B.

A transmitter 89 is arranged to send usage data to the network node and to transmit a request for missing parts. This module corresponds to the obtain content from network step 39 of FIGS. 4A-B the transmit usage data step 42 and the request missing parts step of FIG. 4B.

FIG. 10 shows one example of a computer program product 90 comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 56 of FIG. 6 or the computer program product 66 of FIG. 7. While the computer program 91 is here schematically shown as a track on the depicted optical disk, the computer program can be stored in any way which is suitable for the computer program product.

FIG. 11 is a schematic diagram illustrating a vehicle comprising the client device 2 of FIGS. 1, 7 and 9. The vehicle 99 can be any suitable vehicle for transportation of people and/or goods on land, sea, air or space. The vehicle 99 comprises a client device 2. The client device 2 is explained in more detail above.

The invention has mainly been described above with reference to a few embodiments. However, as is readily appreciated by a person skilled in the art, other embodiments than the ones disclosed above are equally possible within the scope of the invention, as defined by the appended patent claims.

1. A method for obtaining caching content, the method being performed in a client device and comprising the steps of:
receiving caching content from a network node, the transmission of the caching content being initiated by the network node;
storing the caching content in a client device cache;
determining a need to obtain requested content;
checking whether the client device cache comprises caching content corresponding to the requested content; and
obtaining the requested content from the client device cache when the client device cache comprises caching content corresponding to the requested content.

2-8. (canceled)

9. A client device for obtaining caching content, the client device comprising:
a processor; and
a memory storing instructions (66) that, when executed by the processor, causes the client device to:
receive caching content from a network node, the transmission of the caching content being initiated by the network node;
store the caching content in a client device cache;
determine a need to obtain requested content;
check whether the client device cache comprises caching content corresponding to the requested content; and
obtain the requested content from the client device cache when the client device cache comprises caching content corresponding to the requested content.

10. The client device of claim 9, wherein the instructions to store comprise instructions that, when executed by the processor, causes the client device to store the caching content in an encrypted form.

11. The client device of claim 9, further comprising instructions that, when executed by the processor, causes the client device to:
receive a cache retention policy from the network node; and
discard caching content when expired in accordance with the cache control policy.

12. The client device of claim 9, wherein the instructions to receive caching content comprise instructions that, when executed by the processor, causes the client device to receive caching content over a broadcast connection.

13. The client device of claim 9, further comprising instructions that, when executed by the processor, causes the client device to:
transmit usage data of the client device cache.

14. The client device of claim 13, further comprising instructions that, when executed by the processor, causes the client device to:
receive a reporting policy from the network node;
and wherein the instructions to transmit usage data comprise instructions to transmit usage data in accordance with the reporting policy.

15. The client device of claim 14, wherein the reporting policy comprises an indication to encrypt usage data; and wherein the instructions to transmit usage data comprises instructions that, when executed by the processor, causes the client device to encrypt the usage data and transmitting the encrypted usage data.

16. The client device of claim 9, further comprising instructions that, when executed by the processor, causes the client device to:
receive auxiliary caching content from a network node, the transmission of the auxiliary caching content being initiated by the network node;
and wherein the instructions to obtain the requested content comprise instructions to combine the requested content and the auxiliary caching content.

17. A vehicle comprising the client device of claim 9.

18. A computer program comprising computer program code which, when run on a client device, causes the client device to:
receive caching content from a network node, the transmission of caching content being initiated by the network node;
store the caching content in a client device cache;
determine a need to obtain requested content;
check whether the client device cache comprises caching content corresponding to the requested content; and
obtain the requested content from the client device cache when the client device cache comprises caching content corresponding to the requested content.

19. A computer program product comprising a computer program of claim 18 and a computer readable means on which the computer program is stored.

20-25. (canceled)

26. A network node for providing caching content to client devices, the network node comprising:
a processor; and
a memory storing instructions that, when executed by the processor, causes the network node to:
determine a need to store caching content in the client devices; and
transmit caching content to the client devices, the transmission of caching content being initiated by the network node.

27. The network node of claim 26, wherein the instructions to transmit caching content comprises instructions that, when executed by the processor, causes the network node to transmit caching content over a broadcast connection.

28. The network node of claim 26, wherein the instructions to transmit caching content comprises instructions that, when executed by the processor, causes the network node to transmit caching content.

29. The network node of claim 26, further comprising instructions that, when executed by the processor, causes the network node to:
transmit auxiliary caching content to the client devices for combining with caching content, the transmission of the auxiliary caching content being initiated by the network node.

30. The network node of claim 26, further comprising instructions that, when executed by the processor, causes the network node to:
transmit a cache retention policy to the client devices.

31. The network node of claim 26, further comprising instructions that, when executed by the processor, causes the network node to:
transmit a reporting policy to the client devices.

32. A computer program comprising computer program code which, when run on a network node, causes the network node to:
determine a need to store caching content in the client devices; and
transmit caching content to the client devices, the transmission of caching content being initiated by the network node.

33. A computer program product comprising a computer program of claim 32 and a computer readable means on which the computer program is stored.
